(19) United States
(12) Patent Application Publication
(10) Pub. No.: US 2020/0409553 A1
(43) Pub. Date: Dec. 31, 2020

(54) METHOD OF STORING AND ACCESSING DATA

(71) Applicant: A.A.A. TARANIS VISUAL LTD., Tel Aviv (IL)

(72) Inventors: Ofir SCHLAM, Tel Aviv (IL); Eli BUKCHIN, Ramat Gan (IL)

(73) Assignee: A.A.A. TARANlS VISUAL LTD, Tel Aviv (IL)

(21) Appl. No.: 16/071,039

(22) PCT Filed: Jan. 5, 2017
(86) PCT No.: PCT/IB2017/050034

§ 371 Date: Jul. 18, 2018

(30) Foreign Application Priority Data
Jan. 18, 2016 (GB) 1600849.2

(51) Int. Cl. G06F 3/06

(52) U.S. Cl. CPC G06F 3/064; G06F 3/0673; G06F 3/0604

(57) ABSTRACT

A method of storing and accessing data comprising receiving an initial data block, dividing the initial data block into a plurality of initial subblocks, each initial subblock being the same size, storing each subblock in accordance with a data schema, generating a set of calculated subblocks, each calculated subblock being generated from a plurality of initial subblocks, such that each calculated subblock is the same size as an initial subblocks, storing the calculated subblocks in accordance with the data schema, and generating a reference structure, the reference structure comprising a pointer to each of the stored subblocks.

The present invention relates to storing and accessing data, particularly but not exclusively for use with meteorological data.

### BACKGROUND TO THE INVENTION

In applications which use large amounts of data, in particular geo-spatial data such as in the fields of meteorology and oceanography, both the raw data from actual measurements and data from simulations or forecasts can be enormous, for example on the order of petabytes. The data is usually divided into many files in an appropriate format, such as GRIB2 or NetCDF. For specific uses the files may contain a large amount of unneeded data. One standard solution is to download the data and post-process the data to retrieve only those elements of interest. In this process the downloaded data is stripped from the original files and stored locally while the original data files are then discarded. The solution is still not completely satisfactory. First, in order to obtain relevant data, it is necessary to download the entire dataset, and in the case of a data error or an update to the data schema, the files need to be downloaded again. This approach has a large overhead that depends on the network communication rate.

As a further issue, even when only the relevant data is finally downloaded and saved, the data may be stored in a way which is slow to access, requiring a large number of memory and computational actions, for example from scanning the stored data to identify the data of interest. In addition, the download data may not be on the scale required, and a different geographical spacing of data point may be desired or sufficient.

### SUMMARY OF THE INVENTION

According to a first aspect of the invention there is provided a method of storing and accessing data comprising receiving an initial data block, dividing the initial data block into a plurality of initial subblocks, each initial subblock being the same size, storing each subblock in accordance with a data schema, generating a set of calculated subblocks, each calculated subblock being generated from a plurality of initial subblocks, such that each calculated subblock is the same size as an initial subblocks, storing the calculated subblocks in accordance with the data schema, and generating a reference structure, the reference structure comprising a pointer to each of the stored subblocks.

Each calculated subblock may be generated from four initial subblocks.

The method may comprise generating a further set of further calculated subblocks, each further calculated subblock being generated from one of a plurality of calculated subblocks, or the plurality of initial subblocks from which the calculated subblocks are generated, wherein each of the further calculated subblocks is the same size as an initial subblock, the method further comprising storing the further calculated subblocks in accordance with the data schema and adding a pointer to each of the stored further calculated subblocks to the reference structure.

Each further calculated subblock may be based on four calculated subblocks or 16 initial subblocks.

The method may comprise performing the steps of generating additional sets of calculated subblocks based on the further calculated subblocks.

The reference structure may comprise a quad-tree, each node corresponding to a subblock comprising the pointer to the stored subblocks and, where the subblock comprises a calculated subblock, a pointer to each node of the tree relating to a subblock from which the calculated subblock was generated.

The data may comprise gridded data.

The method may comprise obtaining the initial data block by selectively obtaining data from a data source comprising an index file, the method comprising reading the index file to identify required data within the data source, and downloading the required data accordingly.

The data may comprise meteorological data.

### BRIEF DESCRIPTION OF THE DRAWINGS

Embodiments of the invention are described by way of example only with reference to the accompanying drawings, wherein;

FIG. 1 is a diagrammatic illustration of a computer system to download and process data in accordance with the present invention;

FIG. 2 is a flow diagram illustrating a method of downloading specific data elements from a larger dataset;

FIG. 3a is a diagrammatic illustration of gridded data divided into subblocks;

FIG. 3b is a flow diagram showing generating a further subblock from a plurality of the subblocks of FIG. 3a;

FIG. 3c is a diagram showing successive generation of further subblocks;

FIG. 3d is a diagrammatic illustration of a reference structure corresponding to a plurality of subblocks;

FIG. 4a is a diagrammatic illustration of data stored in memory blocks corresponding to subblocks according to a schema;

FIG. 4b is a diagrammatic illustration of a schema for storing data within a memory block of FIG. 4a; and

FIG. 5 is a flowchart showing steps of retrieving data stored in accordance with the scheme of FIG. 4.

### DETAILED DESCRIPTION OF THE PREFERRED EMBODIMENTS

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In file formats intended to handle large volumes of data, the data is usually compressed but the file includes metadata regarding the information stored in the file. In the present example, a separate index file is provided which describes the data stored in the data file. The data may further be stored in a number of separate sub-files, each comprising a particular part of the data. Where the data is gridded data, the grid characteristics, such as the geometry of the grid, the spacing of the grid points and any other information needed to reconstruct the data are stored together with the data. Although the present invention is discussed with reference to meteorological and oceanographic data, it will be apparent that the methods and apparatus described herein may be used with any other application with periodic or otherwise structured data.

An example computer apparatus for implementing the present invention is illustrated at 10 in FIG. 1. A computer is shown at 11, having a processing apparatus generally shown at 12 and a local memory or other suitable accessible storage shown at 13. The computer also has a suitable storage apparatus 14, for example an array of disks or any other storage mechanism as appropriate. The processing apparatus 12 is preferably multithreaded, allowing multiple processes to operate in parallel on data held in the memory 13. Raw data may be held on the storage apparatus 14, as shown at 15, or may alternatively be stored on a remote apparatus 16 and accessed through a network connection 17, for example a local or wide area network, or the internet or any other network combination as required.

### Selective Data Fetching

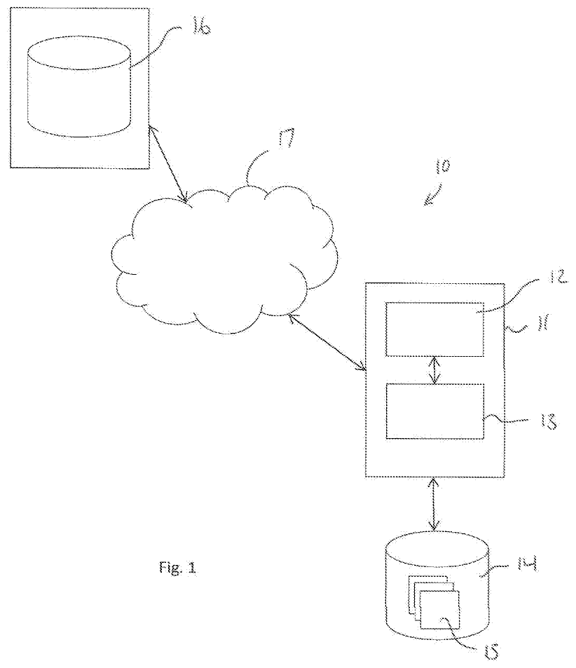

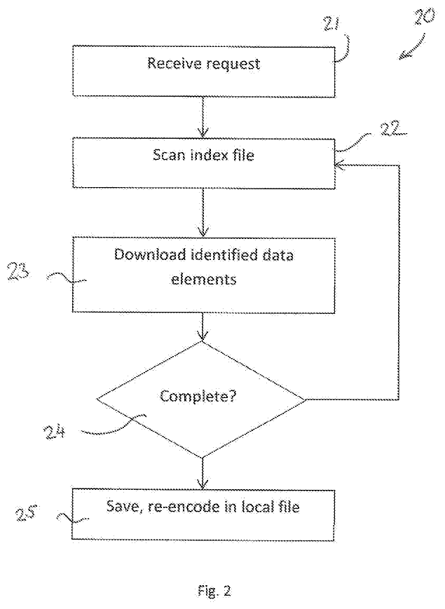

A method of selectively fetching required data is shown at 20 in FIG. 2. At step 21, the relevant subset of the data required from the file 15 is identified. At step 22, the index is scanned, and at step 23, where a relevant data element is identified, the data element is downloaded. If the relevant part of the data file has been not have been completely scanned, then as shown at 24 the process is repeated until scanning the index file and downloading data is complete. At step 25 the downloaded data is saved and then re-encoded into a local version and stored, for example in the storage apparatus 14.

For example, in a meteorological data file it is desired to obtain the temperature at surface level. The index file of the specific GRIB data file is downloaded, and is then searched for the temperature message, i.e. the specific data elements, and level. In this case the index file is searched for the “TMP” element and “surface” level.

Each element and level has its own line in the index file. An example line is 219:134160060:d=2015011800:TMP:surface:12 hour fcst: where 219 is the message number, 134160060 is the start offset of the message data within the GRIB file, d=2015011800 is the creation date of the GRIB, TMP is the element name, surface is the level, and 12 hour fcst is the forecast from the creation date.

To get the end offset the start of the next line is read, i.e. the start offset is retrieved from message 220. Then just a part of the file can be retrieved (from 219's offset to immediately before 200's offset), relating only to the required surface temperature data. A new, local, file with the relevant section can be created and then the data is re-encoded the data to its slimmer local version.

Hence, it can be seen that data is efficiently fetched with only those parts of the data required being downloaded, thus reducing the network overhead.

### Data Storage

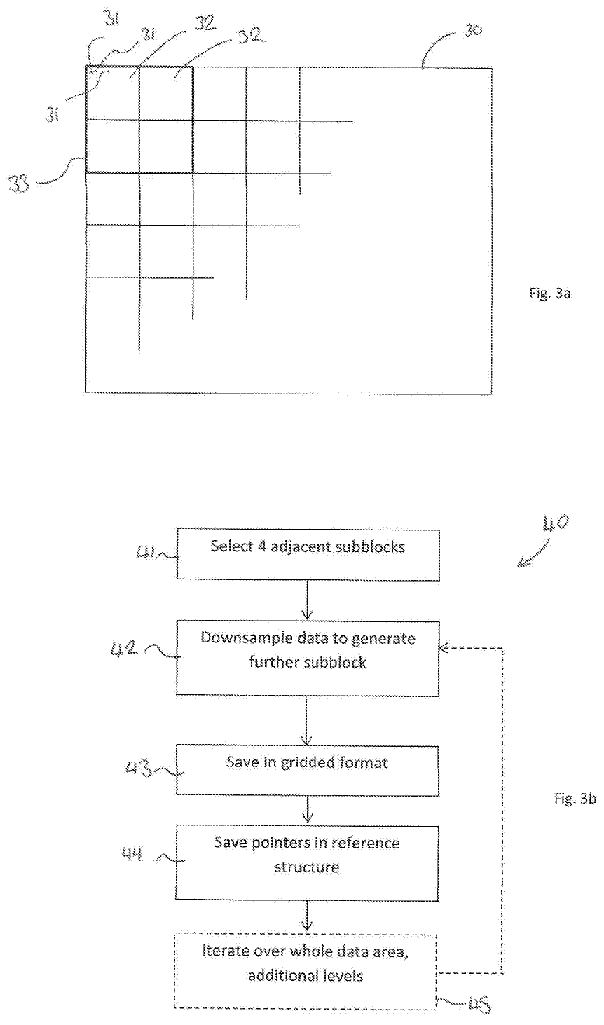

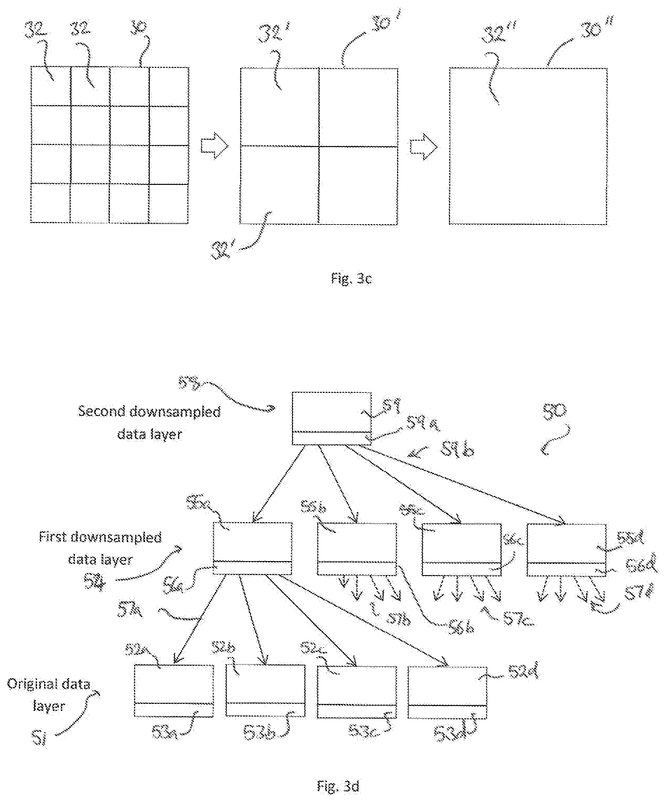

In the present example, the data is gridded as illustrated in FIG. 3a, that is the data are laid out on a regular array shown at 30, with a plurality of points 31 within the array, each point 31 having a number of potential data values associated with it. For example, a point 31 may correspond to a geographical location, and the stored data may be temperature, humidity and pressure at different heights at that point. Although rectilinear grids are shown in FIG. 3a for simplicity, any other arrangement of the data may be used.

The data array 30 is then sub-divided into a plurality of subblocks 32. The subblocks 32 have the characteristic that they are each the same size and shape, and thus contain the same volume of data and cover the same geographical area, i.e. the same number of geographical points. Each subblock 32 is then stored separately, in memory 13 or data storage apparatus 14 in accordance with a consistent schema, as discussed in more detail below. Within the data schema, each data type is stored in a consistent location within the block of memory or storage assigned to that subblock.

The entirety of the data contained in the data grid 30 may not necessarily be required for the calculation to be performed. For example, it may be intended to perform operations on a coarser grid, which reduces the number of initial data points required, or in general the precision in the original data may not be needed. To facilitate this, a further subblock generations step is repeatedly and optionally iteratively performed using a method as shown at 40 in FIG. 3b. At step 41, four adjacent subblocks are retrieved, for example the four subblocks shown in bold outline at 33 in FIG. 3a. At step 42, a further subblock is calculated by downsampling the data in the original plurality of subblocks 32. The downsampling is performed such that the resulting further subblock contains the same number of data points and occupies the same area of memory, as one of the initial subblocks 32. It will be apparent that the further subblocks will all have twice the spacing between data points as one of the initial subblocks 32, and so will have a relatively coarse spacing. The downsampling step may be performed by any suitable method, depending on the degree of acceptable deviation from the original data. At step 43, the further subblock is stored in accordance with the schema as mentioned above, and a step 45 a pointer to the further subblock is saved in a reference tree as discussed below. As shown by dashed method step and arrow 45, this process may be performed iteratively so that each adjacent group 33 of four subblocks 32 is used to generate a further subblock, thus generating a set of further subblocks which has a quarter of the number of original subblocks 32, and covers the same area as the original data.

This method may be performed iteratively to provide as many levels of further subblocks as required. The generation of further subblocks is illustrated in FIG. 3c, where a data grid 30 comprising 4×4 subblocks 32 is used to generate a further data grid 30′ comprising four subblocks 32′. The steps of method 40 are repeated to generate a still further grid 30″ which in this case comprises a single subblock 32″ covering the whole area. It will be apparent that the further subblock 32″ may be generated either from the four subblocks 32′ or from the 16 initial subblocks 32.

Although at each step 4 data subblocks are used to generate a further subblock, it will be apparent that any number or configurations of subblocks may be used to generate a further subblock, providing the resultant subblock is of the same shape, covers the same area and has the same number of data point, as the original subblocks 32.

To provide efficient indexing of the subblocks 32, further subblocks 32′ and additional further subblocks 32″ appropriate, a reference structure is provided as generally shown at 50 in FIG. 3d. The reference structure 50 is a tree which follows the arrangement of subblocks shown in FIG. 3c. A first, lowest layer 51, corresponding to the original subblocks comprising the initial data, comprises a set of leaves 52a, 52b, 52c, 52d. Each leaf 52a, 52b, 52c, 52d comprises a pointer 53a, 53b, 53c, 53d which points to the beginning of the memory block holding the data associated with the subblock 32 to which the leaf 52a, 52b, 52c, 52d relates. Similarly, a second layer 54 comprises a plurality of leaves 55a, 55b, 55c, 55d each relating to one of the further subblocks 32′. Each leaf 55a, 55b, 55c, 55d has a pointer 56a, 56b, 56c, 56d, similarly pointing to the memory location of the data of the corresponding subblock 32′. Each leaf 55a, 55b, 55c, 55d further comprises pointers 57a, 57b, 57c, 57d which point to the location of the leaves 52a, 52b, 52c, 52d relating to the relevant subblocks 32 which were used to generate the further subblock 32′ corresponding to that leaf 55a, 55b, 55c, 55d. In the particular arrangement illustrated in FIG. 3c, there is a third level 58, in this example having a single leaf 59 with a pointer 59a, to the location of the further subblock 32″ in memory, and with a plurality of pointers 59b to the leaves 55a, 55b, 55c, 55d of the second layer 54.

It will be apparent that this reference structure comprises a quad tree, and thus may be traversed by any suitable tree searching or indexing algorithms as generally known. Where a leaf contains no data, for example if the original data grid 30 contains regions in which no data was recorded, that unpopulated area will appear as a null leaf in at least the lowest layer 51, and indeed in higher layers if all of the subblocks making up a further subblock are do not contain data. Accordingly, the reference structure 50 contains references to data subblocks of different resolution and complexity at different levels while holding the original data references at the lowest level.

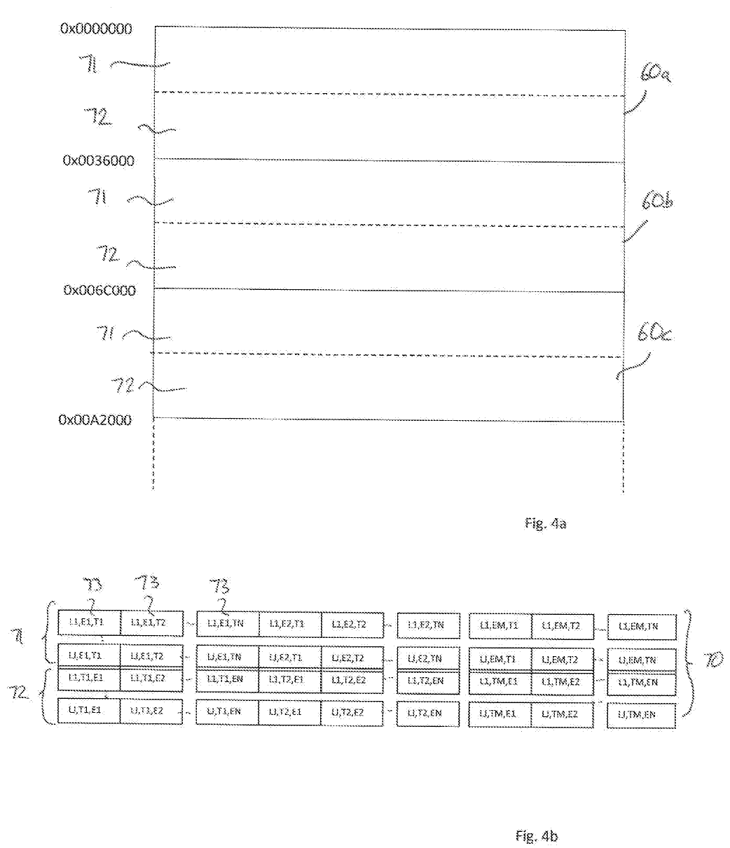

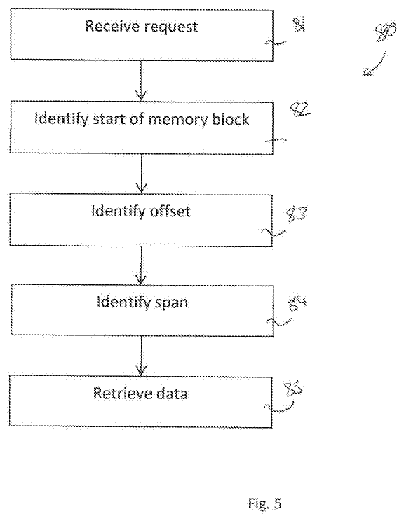

The arrangement of the data in memory is illustrated with reference to FIG. 4. The data is stored in memory as a sequence of blocks 60a, 60b, 60c, each memory block corresponding to a subblock 32 and therefore each of the memory blocks 60a, 60b, 60c are the same size. Each memory block 60a, 60b, 60c holds comprise the same data types arranged in the same position. The start of each memory block is held in the relevant pointer of the corresponding leaf in the reference structure 50 as shown in FIG. 3d. For example, memory block 60a contains the data of the top-level subblock 32″, and pointer 59a points to address 0x000000, the first byte of block 60a. Memory block 60b relates to the first subblock 32′ corresponding to leaf 55a, and so pointer 56a points to address 0x0036000, the first byte of block 60b. Similarly, pointer 56b of leaf 55b points to the first byte 0x006C000 of block 60c, and so on. Accordingly, identifying the location of a relevant block of data within memory is a simple task of traversing the reference structure 50, identified the leaf relating to the geographical area required at the resolution required and then following the pointer that leaf to the relevant area of memory. Specific data types will be offset by a consistent distance from the first byte of the block, and so a particular desired data type can be directly read using a method such as that shown at 80 in FIG. 5. At 81, the request is received and at step 82 the address of the relevant memory block is found by traversing the reference structure 50. The offset of the desired data within the memory block and the span of the desired data are found at 83 and 84. At step 85, the relevant data is read from the identified memory locations.

An example schema for storing data within a memory block 60a, 60b, 60c is shown in FIG. 4b. In this example, the data is meteorological data, and each data point is associated with a geographical location and relates to a particular level L1-LJ, a particular element E1-EM, that is a data type such as temperature, humidity, or pressure, and time T1-TN, whether a time of capture, a forecast time otherwise. The elements will be present in each memory block 60a, 60b, 60c, as will be apparent from the description of the generation of each subblock above, and are arranged in the schema shown at 70 in FIG. 4b. The scheme has two sections, section 71 and section 72. It will be apparent that in section 71, the data is arranged that the data is arranged by level, element and time, whereas in section 72, the data is arranged by level, time and then element. Although the data in each case is repeated, this schema permits faster access to the relevant data. As the data is usually required, either for a particular element over time, or for particular set of elements for a given geographical area, the relevant data can be found by using a suitable mask to identify the relevant section of data from the request. For example, if it is desired to find all data relating to a particular element over a geographical location of interest, the reference structure 50 can be traversed to identify the leaf which relates to the area of interest and resolution of interest. The pointer in that leaf will identify the start of the relevant memory block 60. Because the data is always arranged in a consistent manner within each block 60, and each individual element has the same size, it will be apparent that to find the progression of element E1 at level L1 over the entire span T1-TN, it is necessary just to read the individual data sections shown at 73 of the first part 71 of the relevant data block 60. Further, because within each section 73, the data is arranged in accordance with a known grid, then data at the same memory location with the each section 73, will relates to the same geographical point within the relevant subblock.

This consistent schema allows the use of masks to quickly locate data within each section. In this context a mask is a set of offsets and spans that identify the required data without actually scanning the structure and is derived purely by simple arithmetical calculations based on the unique data schema. A mask is created before the searching begins and the same mask applies to every leaf in the tree thus minimizing drastically the search and sort times.

In a step-by-step example, consider a 256×256 grid, with three elements: T (Temperature), RH (Relative humidity) and W (Wind Speed), spanning spanning 3 Levels: SFC (Surface), 850 mb and 500 mb at times 00:00 06:00 and 12:00. If a user is interested in a point (x,y) it is possible to deduce (using fast quad-tree indexing) the relevant grid index of the point, calculate the offset (g_offset) of the point inside the memory block and potentially calculate in advance the offset and span of the solution needed.

For example: if a user requests relative humidity at 850 mb from 00 to 12 the offset will be: G[i]+0x1000*(9+3) with a span of: 0x1000*3. The required data is at (+g_offset, +g_offset+0x1000, +g_offset+0x2000). This requires only two caching operations and 6 memory access operations in order to find and access the data, where G[i] is the starting byte of the relevant memory block.

Using multithreaded operation allows more efficient processing of requests. Incoming requests can be sorted and grouped according their spatial and temporal parameters. Each group corresponds to a line in the schema in FIG. 4b. Then, for each such line, a worker thread is started, which processes all the requests and stores their result. This allows for each thread to access a separate set of data clusters, and thus completely parallelize the process, in connection with memory usage and HD usage.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

Meanings of technical and scientific terms used herein are to be commonly understood as by one of ordinary skill in the art to which the invention belongs, unless otherwise defined.

1. A method of storing and accessing data comprising;
receiving an initial data block,
dividing the initial data block into a plurality of initial subblocks, each initial subblock being the same size,
storing each subblock in accordance with a data schema,
generating a set of calculated subblocks, each calculated subblock being generated from a plurality of initial subblocks, such that each calculated subblock is the same size as an initial subblocks,
storing the calculated subblocks in accordance with the data schema,
and generating a reference structure, the reference structure comprising a pointer to each of the stored subblocks.

2. A method according to claim 1 where each calculated subblock is generated from four initial subblocks.

3. A method according to claim 2 comprising generating a further set of further calculated subblocks, each further calculated subblock being generated from one of;
a plurality of calculated subblocks, or
the plurality of initial subblocks from which the calculated subblocks are generated;
wherein each of the further calculated subblocks is the same size as an initial subblock,
the method further comprising storing the further calculated subblocks in accordance with the data schema and adding a pointer to each of the stored further calculated subblocks to the reference structure.

4. A method according to claim 3 where each further calculated subblock is based on four calculated subblocks or 16 initial subblocks.

5. A method according to claim 3 comprising performing the steps of generating additional sets of calculated subblocks based on the further calculated subblocks.

6. A method according to claim 1 wherein the reference structure comprises a quad-tree, each node corresponding to a subblock comprising the pointer to the stored subblocks and, where the subblock comprises a calculated subblock, a pointer to each node of the tree relating to a subblock from which the calculated subblock was generated.

7. A method according to claim 1 wherein the data comprises gridded data.

8. A method according to claim 1 comprising obtaining the initial data block by selectively obtaining data from a data source comprising an index file, the method comprising reading the index file to identify required data within the data source, and downloading the required data accordingly.

9. A method according to claim 1 wherein the data comprises meteorological data.
